(19) United States
(12) Patent Application Publication
(10) Pub. No.: US 2019/0186837 A1
(43) Pub. Date: Jun. 20, 2019

(54) LOCATING MECHANISM FOR HEAT EXCHANGER ASSEMBLY

(71) Applicant: DANA CANADA CORPORATION, OAKVILLE (CA)

(72) Inventors: TAKAYUKI FUKADA, MISSISSAUGA (CA); JOSEPH A. KAMENSKI, HAMILTON (CA)

(73) Assignee: DANA CANADA CORPORATION, OAKVILLE, ON (CA)

(21) Appl. No.: 16/328,517

(22) PCT Filed: Aug. 25, 2017
(86) PCT No.: PCT/CA2017/051000

§ 371 Date: Feb. 26, 2019

Related U.S. Application Data
(60) Provisional application No. 62/380,098, filed on Aug. 26, 2016.

(51) Int. Cl. F28D 9/00; B21D 53/04; B23P 15/26; F28D 1/03; F28F 9/02; F28F 27/02

(52) U.S. Cl. CPC F28D 9/005; B21D 53/04; B23P 15/26; F28F 2280/08; F28F 9/0253; F28F 27/02; F28F 2275/045; F28D 1/0341

(57) ABSTRACT

A heat exchanger assembly, having a heat exchanger having at least a plate pair, the plate pair defining a fluid passage for flow of fluid for heat exchange, and optionally coupled a base plate of the heat exchanger assembly. A component coupled to the heat exchanger or the base plate of the heat exchanger assembly, where the base plate is coupled to a bottom plate of the heat exchanger; the component having a plurality of parts, where one part of the plurality of parts has one or more protuberances, the one or more protuberances engaging a slit or cut-out for coupling the component.

### FIELD

The invention relates to a heat exchanger assembly and a method for positioning components on the heat exchanger assembly.

### BACKGROUND

In forming a heat exchanger assembly, different components, such as a heat exchanger and parts that may have one or more pieces, which co-operate with the heat exchanger are coupled to a frame or base plate to form the heat exchanger assembly. The heat exchanger core, formed of heat exchanger plates, is typically brazed to couple the heat exchanger plates together, and which provide the fluid paths for flow of fluids for heat exchange. The heat exchanger core used and described in the application should be known a person of skill in the art, and can be varied depending upon application and design requirements. The heat exchanger core and other parts that co-operate with the heat exchanger can be coupled to the base plate by brazing, welding, affixing or bolting. However, proper positioning and alignment of the parts (that co-operate with the heat exchanger core) to attain precision on the frame or base plate prior to brazing can be challenging, leading to non-functional devices or devices having lower precision than required.

US Patent Publication No. US2013/0319634 A1 relates to various ways in which to integrate control valves into the structure of a heat exchanger. Accordingly, there is provided a heat exchanger assembly comprising a heat exchanger and a valve integration unit. The heat exchanger includes a plurality of alternating first and second fluid passages in heat exchange relation, and at least one inlet manifold and one outlet manifold interconnected by one of the plurality of first or second fluid passages, the valve integration unit being fixedly attached to heat exchanger and comprising a fluid passage in fluid communication with at least one of the inlet and outlet manifolds. A valve mechanism is mounted within the valve integration unit in fluid communication with the fluid passage, the valve mechanism controlling the flow of a heat exchange fluid through said fluid passage.

U.S. Pat. No. 7,748,442 B2 relates to plate heat exchanger for cooling a first fluid by a second fluid, including a plurality of stacked heat exchanger plates forming separate flow channels therebetween with a cover plate on one side and a base plate on the other side of the stacked plates. The plates have a plurality of aligned openings defining inlet and outlet channels each communicating with selected ones of connected flow channels. In one form, the cover plate includes a conveying channel guiding one of the fluids to a desired position along the length of the heat exchanger, and the base plate includes a conveying channel guiding the other of the fluids to a desired position along the length of the heat exchanger. In another form, the conveying channels for both of the fluids are in the same one of the cover or base plate. When such conveying channels are formed by structures separately coupled to the cover or base plate, their positioning can be challenging, and misalignment can affect device efficiency.

There is a need in the art on a method for properly aligning parts in a heat exchanger assembly to avoid loss of efficiency, while helping to attain maximum accuracy and efficiency.

### SUMMARY OF INVENTION

In one aspect, the specification relates to a heat exchanger assembly having:

a heat exchanger having at least a plate pair, the plate pair defining a fluid passage for flow of fluid for heat exchange, and optionally coupled a base plate of the heat exchanger assembly; and

a component coupled to the heat exchanger or the base plate of the heat exchanger assembly, where the base plate is coupled to a bottom plate of the heat exchanger; the component having a plurality of parts, where one part of the plurality of parts has one or more protuberances, the one or more protuberances engaging a slit or cut-out for coupling the component.

In another aspect, the specification relates to a method for forming a heat exchanger assembly, the method containing the steps of:

coupling at least a plate pair for forming the heat exchanger, the plate pair defining a fluid passage for flow of fluid for heat exchange, the heat exchanger optionally having a base plate; and

coupling a component to the heat exchanger or the base plate of the heat exchanger assembly, where the base plate is coupled to a bottom plate of the heat exchanger; the component having a plurality of parts, where one part of the plurality of parts has one or more protuberances, the one or more protuberances engaging a slit or cut-out for coupling the component.

### BRIEF DESCRIPTION OF THE DRAWINGS

Reference will now be made, by way of example, to the accompanying drawings which show example embodiments of the present application, and in which:

FIG. 1 is an exploded front side plan view of a heat exchanger assembly according to a first embodiment disclosed in the specification;

FIG. 2 is an exploded top perspective view from the front side of a heat exchanger assembly according to the first embodiment disclosed in the specification;

FIG. 3 is an exploded top perspective view from a first side of a heat exchanger assembly according to the first embodiment disclosed in the specification;

FIG. 4 is an exploded top perspective view from a second side of a heat exchanger assembly according to the first embodiment disclosed in the specification;

FIG. 5 is a perspective view of a heat exchanger assembly according to the first embodiment disclosed in the specification;

FIG. 6 is a perspective view of a heat exchanger assembly according to a second embodiment disclosed in the specification;

FIG. 7 is an exploded bottom perspective view from the front side of a heat exchanger assembly according to the second embodiment disclosed in the specification;

FIG. 8 is an exploded top perspective view from the front side of a heat exchanger assembly according to the second embodiment disclosed in the specification;

FIG. 9 is an exploded side plan view from the front side of a heat exchanger assembly according to the second embodiment disclosed in the specification;

FIG. 10 is a perspective view of a heat exchanger assembly according to the third embodiment disclosed in the specification;

FIG. 11 is an exploded perspective view of a heat exchanger assembly according to the third embodiment disclosed in the specification;

FIG. 12 is an exploded side perspective view a heat exchanger assembly according to the third embodiment disclosed in the specification;

FIG. 13 shows a perspective view of a heat exchanger assembly according to the fourth embodiment disclosed in the specification;

FIG. 14 shows an exploded perspective view of a heat exchanger assembly according to the fourth embodiment disclosed in the specification;

FIG. 15 shows an exploded top perspective view from one side of a heat exchanger assembly according to the fourth embodiment disclosed in the specification; and

FIG. 16 shows an exploded top perspective view from second side of a heat exchanger assembly according to the fourth embodiment disclosed in the specification.

Similar reference numerals may have been used in different figures to denote similar components.

### DESCRIPTION OF EXAMPLE EMBODIMENTS

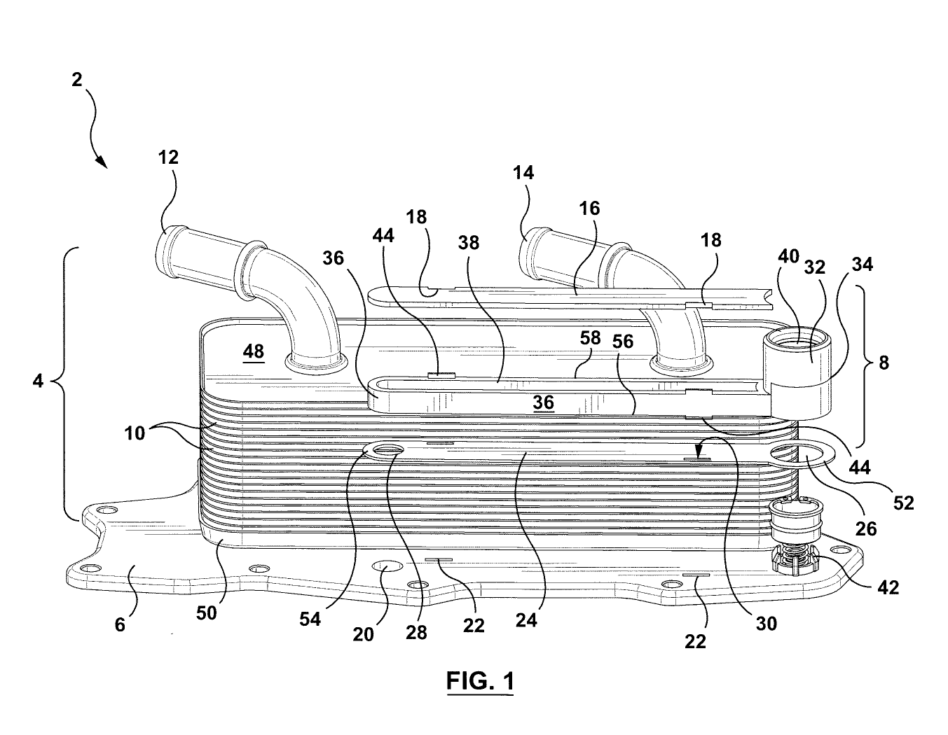

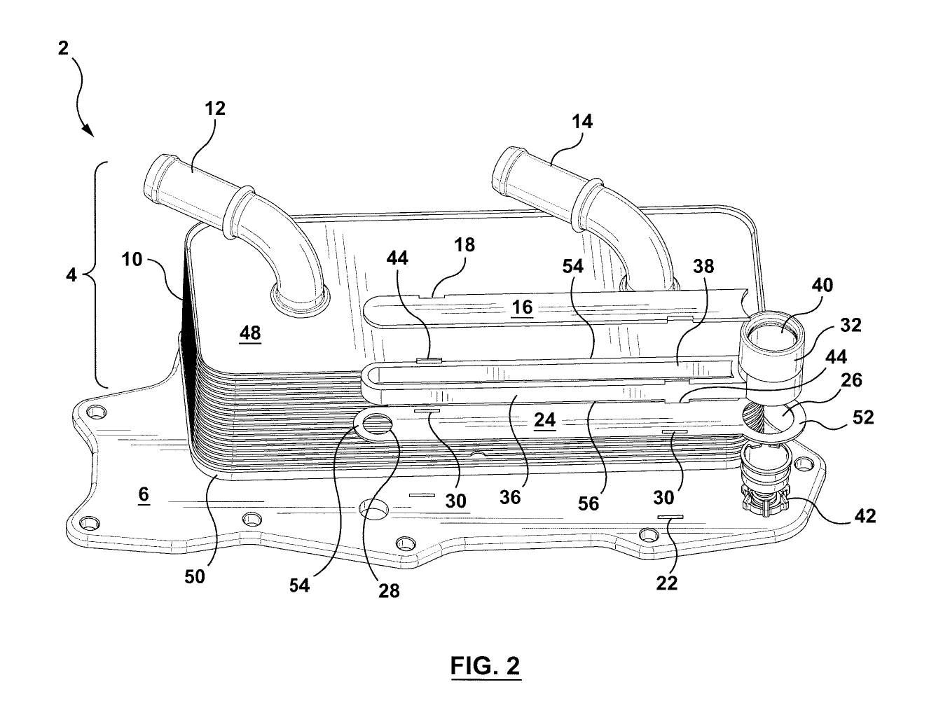

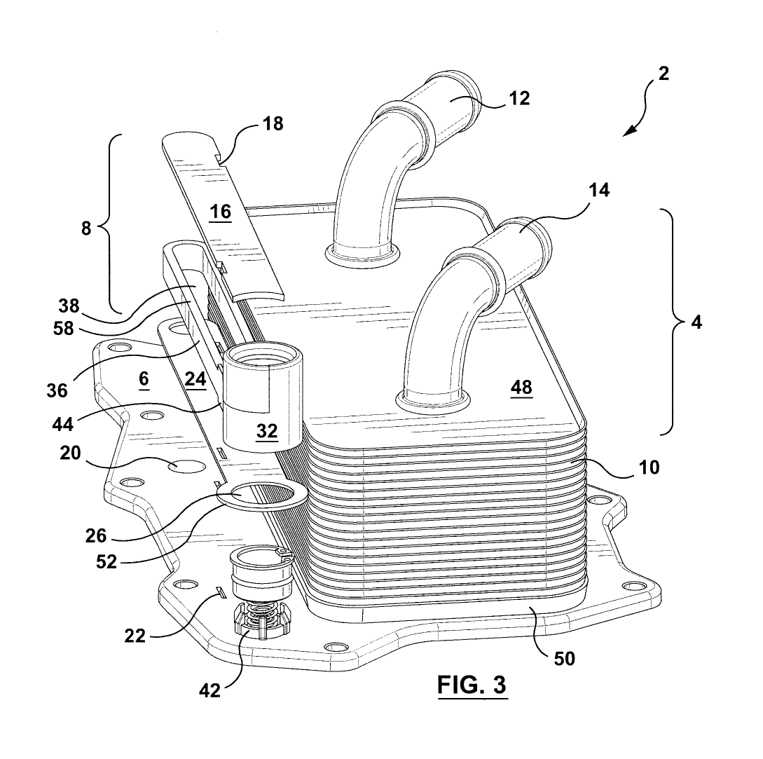

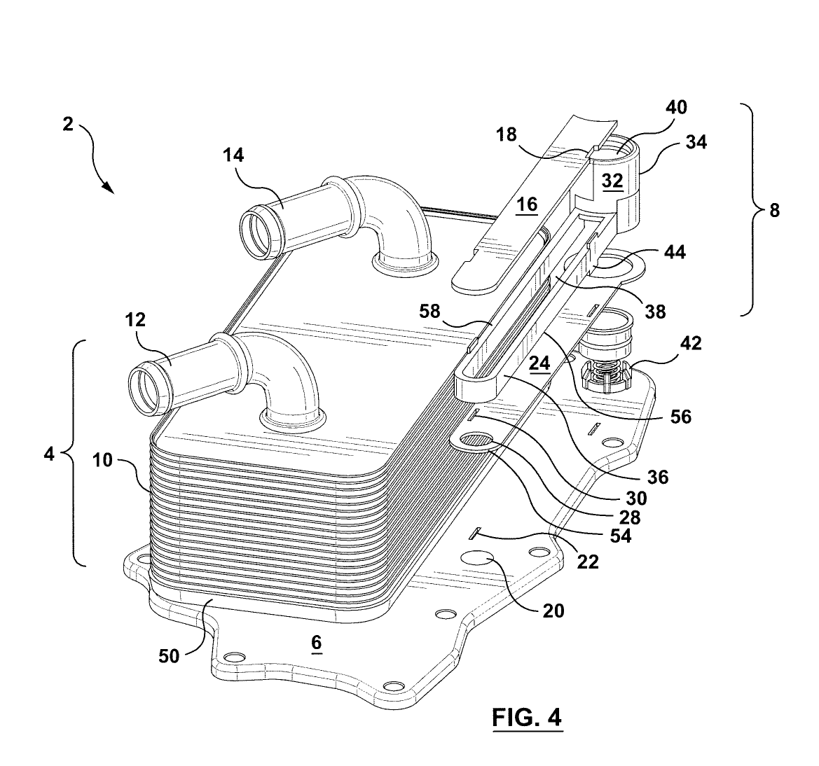

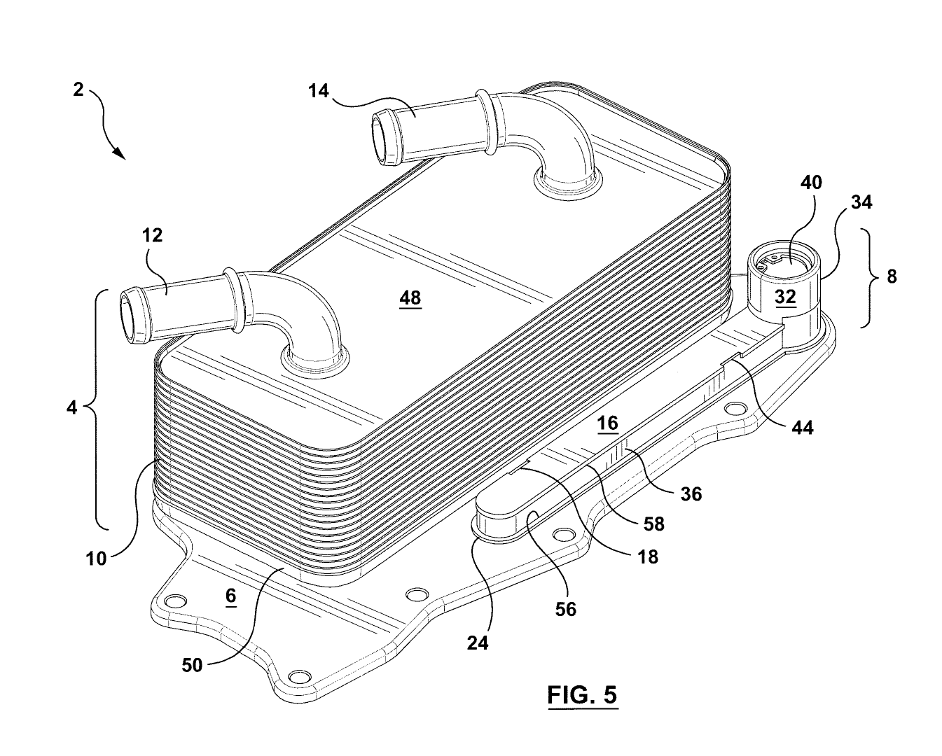

FIGS. 1-5 disclose a first embodiment of a heat exchanger assembly 2.

The heat exchanger assembly 2 is made up of at least three components to form the heat exchanger assembly 2, and include a base plate 6 that provides the framework for coupling to a heat exchanger 4 and a valve integration unit 8. Although, the figures show exploded views of the three components (heat exchanger 4, a valve integration unit 8 and base plate 6), when assembled to form the heat exchanger assembly 2, the heat exchanger 4 and the valve integration unit 8 can be affixed to the base plate 6, as described herein.

The type of heat exchanger 4 used is not particularly limited and can vary depending upon the design and application requirements. In one embodiment, as shown in the figures, a dish-type heat exchanger is attached to the base plate 6, however, as should be recognized by a person of ordinary skill in the art, other types of heat exchangers, such as, for example and without limitation, a plate-type heat exchanger can also be used.

The heat exchanger 4 is formed using a plurality of heat exchanger plates 10, which may or may not be identical, and form the heat exchanger core by providing the surface of heat exchange for the fluids flowing therein. In the embodiment disclosed, the plurality of heat exchanger plates 10 are sandwiched between a top plate 48 and a bottom plate 50 of the heat exchanger core. As should be known to a person of ordinary skill in the art, the plurality of heat exchanger plates 10 together define a first fluid passage (not shown) and a second fluid passage (not shown) for flow of a first fluid and a second fluid, respectively. The first fluid passage and the second fluid passage are thermally coupled, such that the first fluid flowing through the first fluid passage can undergo heat exchange with the second fluid flowing through the second fluid passage, and vice versa; hence, permitting heat exchange between the first and second fluids.

The heat exchanger 4 also has a first fluid inlet manifold (not shown) that is coupled to the first fluid passage. The first fluid inlet manifold is also provided with a first fluid inlet 12 to allow a first fluid to flow into the heat exchanger core. A first fluid outlet manifold (not shown) is also provided and is also coupled to the first fluid passage. The first fluid outlet manifold is also provided with a first fluid outlet 14, to allow the first fluid from the first fluid inlet manifold that enters through the first fluid inlet 12 to pass through the first fluid passage and then flow into the first fluid outlet manifold before passing out through the first fluid outlet 14.

Similar to the above for flow of a first fluid, a second fluid inlet manifold (not shown) having a second fluid inlet is coupled to the second fluid passage at one end. While a second fluid outlet manifold (not shown) having a second fluid outlet is coupled to the second fluid passage at a second end of the second fluid passage. The second fluid passage being in fluid communication with the second fluid inlet manifold and the second fluid outlet manifold permitting second fluid flow from the second fluid inlet, passing through the second fluid inlet manifold to the second fluid outlet manifold before exiting through the second fluid outlet.

The base plate 6 in the heat exchanger assembly 2 provides the framework for attachment and coupling of the heat exchanger 4 and the valve integration unit 8. To form the heat exchanger assembly 2, the bottom plate 50 of heat exchanger (after properly positioning the components of the heat exchanger, as described above) is placed on the base plate 6 before coupling the heat exchanger 4 to the base plate 6. The method of coupling is not particularly limited, and can vary depending upon the design and application requirements. In one embodiment, for example and without limitation, the bottom plate 50 of the heat exchanger 4 is brazed to the base plate 6, for coupling the heat exchanger 4 and base plate 6.

The shape and design of the base plate 6 is not particularly limited and can vary depending upon the design and application requirements. The base plate 6 is designed or structured to have sufficient footprint and strength for affixing the heat exchanger 4 and the valve integration unit 8 to the base plate 6. In the embodiment shown in the figures, the heat exchanger 4 is positioned adjacent to the valve integration unit 8, and on the same side of the base plate 6.

In the embodiment shown in the figures, the base plate 6 is provided with a pair of openings 20 and one or more slits 22. In the embodiment shown, one of openings of the pair of openings 16 has the valve assembly 42 positioned on it for control of flow. The pair of openings 20 allows fluid communication with the valve integration unit 8 as described below, while the slit 22 is utilized for coupling the valve integration unit 8 to the base plate 6, as described below.

Although the embodiment disclosed in the figures relating to the base plate 6 can provided with a plurality of openings, depending upon the design and application requirements, some of the openings may or may not be present. For instance, in one embodiment, where a different type of heat exchanger is used, additional pairs of openings can be provided that are in fluid communication with the first fluid and/or second fluid flowing through the heat exchanger core.

The valve integration unit 8 contains a brazing sheet 24, a valve housing 32 and a valve assembly 42; with the valve assembly 42 generally positioned within the valve housing 32 and in between the valve housing 32 and brazing sheet 24. In coupling the valve integration unit 8 to the base plate 6, the brazing sheet 24 is sandwiched between the valve housing 32 and the base plate 6.

In the embodiment shown in the figures, the brazing sheet 24 is formed by a piece of strip having a first aperture 26 at the first end 52 of the brazing sheet 24, a second aperture 28 at the second end 54 of the brazing sheet and one or more slots 30. The first aperture 26 at the first end 52 of the brazing sheet 24 being formed so that it is fluidly aligned with the one of the pair of openings 20 in the base plate 6, to allow a fluid to flow through the first aperture 26 to the opening 20 in the base plate, or vice versa. In a preferred embodiment, the edge of the brazing sheet 24 defining the first aperture 26 is aligned with the edge of the base plate 6 defining one of the openings 20 in the base plate 6. Similar to the first aperture 26, the second aperture 28 at the second end of the brazing sheet 24 allows fluid communication between the second aperture 28 and the other opening of the pair of openings 20 in the base plate 6. Moreover, the slot 30 formed in the brazing sheet 24 is in alignment with the slit 22 formed in the base plate 6.

In one embodiment, as shown in the figures, the valve housing 32 has a first end 34, a second end 36 and a channel 38 formed from near the first end 34 to the second 36 to permit fluid flow from the first end 34 to the second end 36. The length of the channel 38 formed permits fluid flow from the first aperture 26 in the brazing sheet 24 to flow along the length of the channel 38 to the second aperture 28 in the brazing sheet 24. The channel 38 can enclosed on one side by a cover plate 16, to control and encase the fluid flow in the channel 38. The cover plate 16 can have one or more cut-outs 18, which can be used for proper alignment and positioning of the cover-plate 16 on the channel 38.

The first end 34 of the valve housing 32 has an orifice 40 that permits fluid entering the orifice to flow into the channel 38 or flow through the first aperture 26 in the brazing sheet 24, and also through one of the pair of openings 20 formed in the base plate 6 that is in fluid alignment with the first aperture 26 in the brazing sheet 24.

In an embodiment as shown in the figures, the valve housing 32 has a generally tubular body with the first end 34 being cylindrical that has a cavity, which is in fluid communication with the channel 38 and the orifice 40. The cavity is formed for positioning a valve assembly 42 within the valve housing 32, where the valve assembly 42 helps to control fluid flow to the channel 38 or permit fluid flow to the first aperture 26 in the brazing sheet 24. In addition, the first end 34 of the valve housing 32 having the orifice 40 can be adapted for coupling to other features or components to allow fluid flow to or from the heat exchanger assembly 2.

Along the length of the valve housing 32, one or more protuberances 44 are formed on a first side 56 of the channel 38, which during assembly or coupling of the valve integration unit 8 pass through the slot 30 in the brazing sheet 24 and engage the slit 22 in the base plate. During coupling of the valve integration unit 8 to the base plate 6, cladding material can be used for brazing the valve integration unit 8 to the base plate 6 and form the heat exchanger assembly 2. The brazing method is not particularly limited and should be known to a person of skill in the art.

Additional protuberances 44 can also be provided on a second side 58 of the channel 38, which during assembly can engage the cut-outs 18 in the cover plate 16 to ensure proper positioning and alignment of the cover plate 16 on the channel 38. Cladding material can be used for brazing the cover plate 16 to the channel 38. Again, the brazing method is not particularly limited and should be known to a person of skill in the art.

The valve assembly 42 used herein is not particularly limited and can varied depending upon design and application requirements. The valve assembly 42 disclosed in the figures can be provided with actuation means to actuate the valve from a first position to a second position, as should be known to a person of ordinary skill in the art. Biasing means, such as spring, can also be provided to bias the valve back from the second position to the first position.

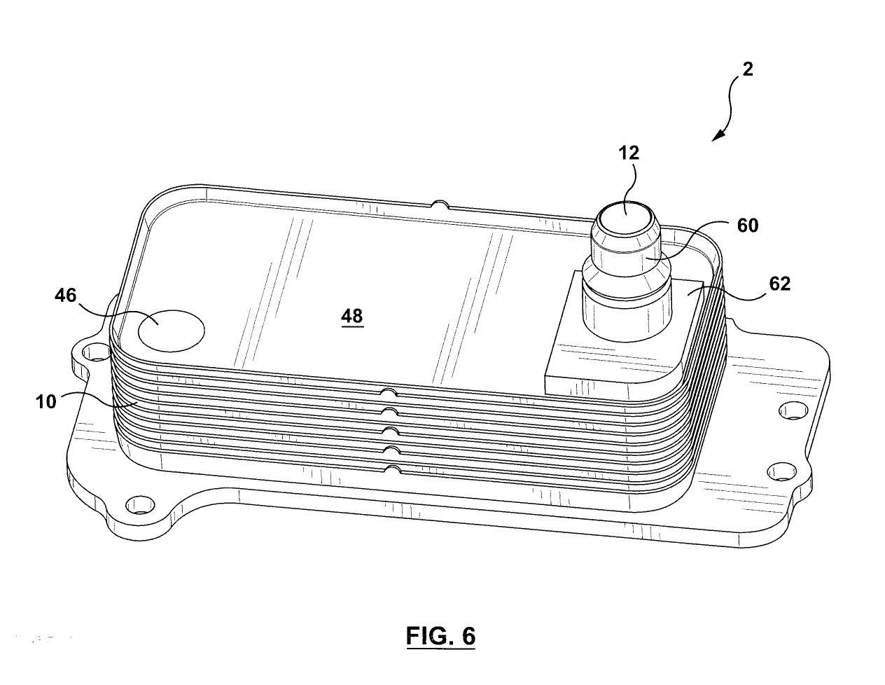

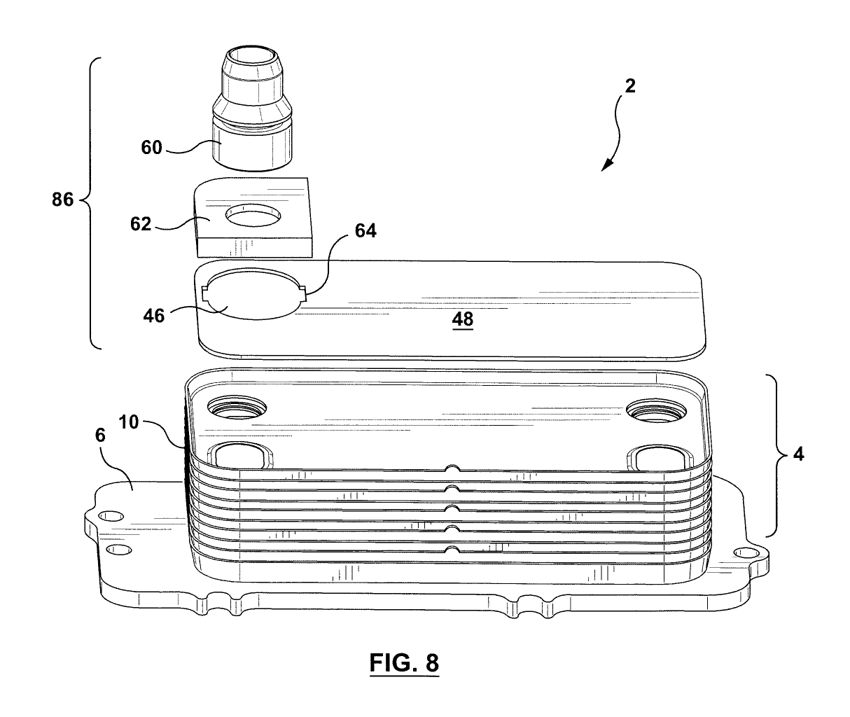

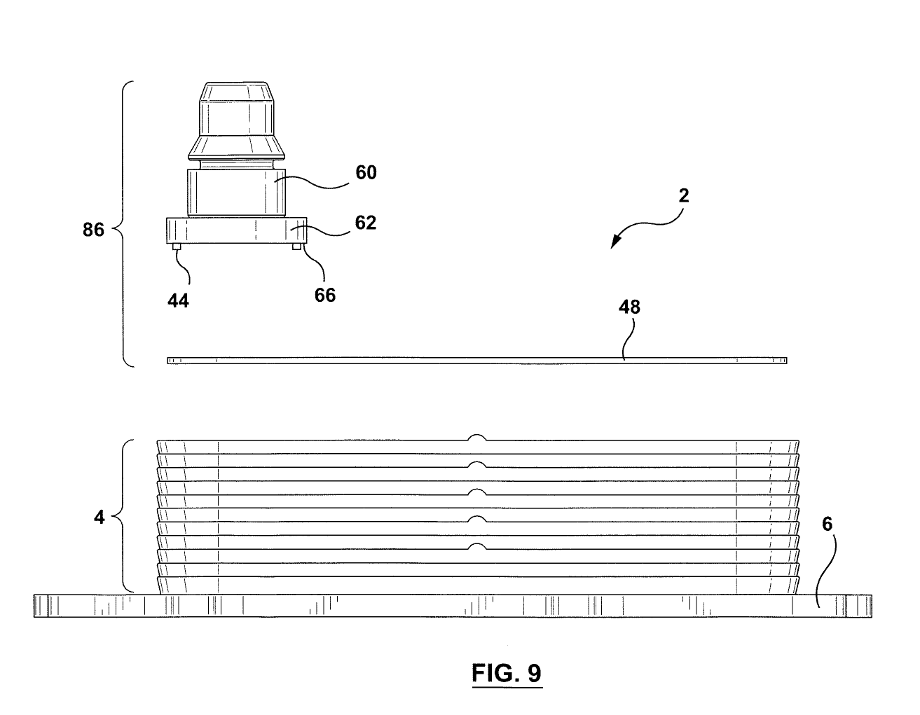

FIGS. 6-9 relate to a second embodiment of a heat exchanger assembly 2 having a locating mechanism for positioning components on the heat exchanger assembly 2, other than the heat exchanger core 4. Although the embodiment shown in FIGS. 6-9 relates to a dish-type plate heat exchanger, the features disclosed herein can be used with other types of heat exchangers as should be recognized a person of skill in the art.

Similar to the first embodiment, FIG. 6 shows a heat exchanger assembly 2 of the second embodiment that has a heat exchanger core formed by a plurality of heat exchanger plates 10, which may be identical or different. The plurality of heat exchanger plates 10 are coupled together to provide fluid passages (not shown) for a first heat exchanger fluid and a second heat exchanger fluid, and permit heat exchange between the first and second heat exchanger fluids, as should be known to a person of skill in the art. The heat exchanger 4 is coupled to a base plate 6 by welding, brazing or other means known to persons of skill in the art.

In addition, the heat exchanger assembly 2 has a fitting assembly 86, where the fitting assembly 86 has a structural plate 62 sandwiched between a brazing sheet 48 and an inlet fitting 60. The brazing sheet 48 is coupled to the top of the plurality of heat exchanger plates 10. The brazing sheet 48 can be provided with apertures 46 (one shown in FIG. 6) that permit a first fluid to flow into a fluid first manifold (not shown) of the heat exchanger 4, and from there the first fluid flows in a first fluid channel (not shown) formed by the plurality of heat exchanger plates 10.

The heat exchanger assembly 2 is provided with one or more fittings 60 coupled to the structural plate 62 and the brazing sheet 48 of the heat exchanger 4. In the second embodiment shown, for purposes of understanding, only a single fitting 60 has been shown. However, as should be recognized by a person of skill in the art, additional fittings 60 can be present. The fitting 60, in the second embodiment, has an inlet 12 for flow of the first fluid into the heat exchanger through the opening 46 in the brazing sheet 48, coupled to the heat exchanger 4. In addition, in a particular embodiment, as shown in FIG. 6, the fitting 60 is coupled to a structural plate 62 that can be affixed to the brazing sheet 48 of the heat exchanger 4, for coupling the fitting 60 to the heat exchanger 4.

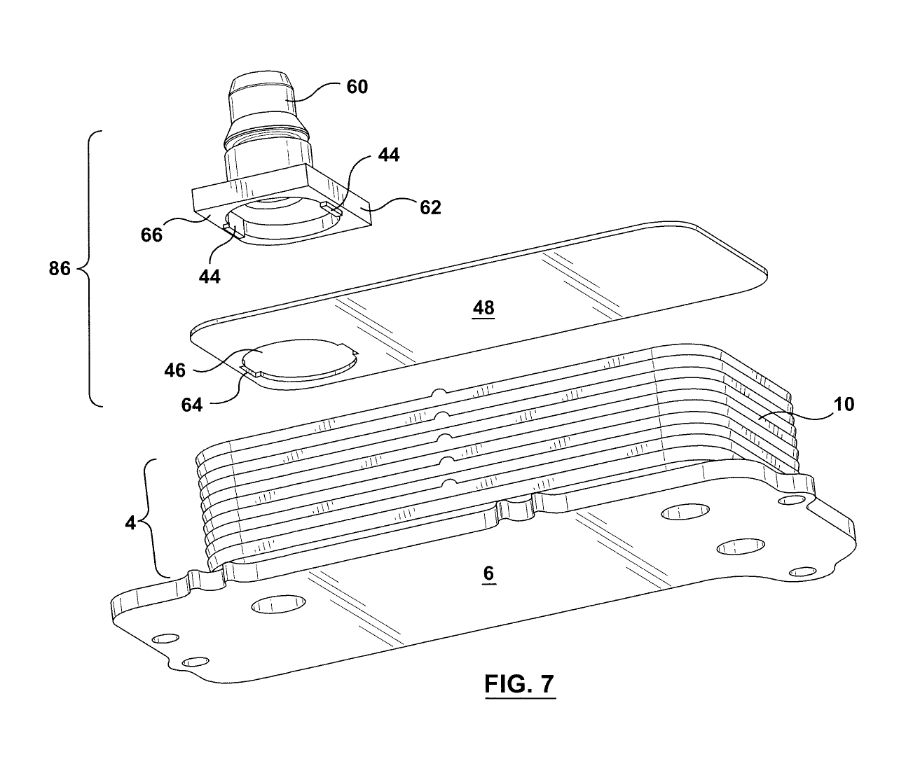

As noted above, and shown in FIGS. 7-9, the brazing sheet 48 coupled to the top plate of the heat exchanger 4 has one or more apertures 46 formed to permit fluid to flow from the inlet 12 of the fitting 60 to the first fluid manifold defined by the plurality of heat exchanger plates 10. The shape of the opening 46 formed in the brazing sheet 48 is not particularly limited and can be varied based on design and application requirements. For instance, the aperture 46 can have a circular shape as shown in FIGS. 7-9, however, other shapes, such as, oblong is also possible.

In addition, the edges of the brazing sheet 48 of the fitting assembly 86 defining the aperture 46 has one or more cut-outs 64 (also noted herein as ‘brazing sheet cut-out’), which can be used for alignment of the fitting 60 on the brazing sheet 48 as described herein. The shape of the brazing sheet cut-out 64 is not particularly limited and can be varied depending upon the design and application requirements, and so long as it can receive the protuberances 44 extending from a surface 66 of the structural plate 62 and help with proper alignment of the fitting 60 on the brazing sheet 48. In the embodiment shown in FIGS. 7-9, the brazing sheet cut-out 64 is generally rectangular in shape.

The structural plate 62 of the fitting 60 has a contact surface 66 that contacts the brazing sheet 48 positioned on the heat exchanger 4 upon positioning the structural plate 62 or fitting 60 to the heat exchanger 4. In the second embodiment shown in FIGS. 7-9, the contact surface 66 of the structural plate 62 is provided with one or more protuberances 44 that extend from the contact surface 66 of the structural plate 62 towards the brazing sheet 48 of the fitting assembly 86 during assembly, and when the fitting 60 is being positioned on the brazing sheet 48. In addition, the protuberances 44 are positioned on the contact surface 66 to be aligned with the brazing sheet cut-outs 64, such that upon proper alignment of the fitting 60 on the brazing sheet 48, the protuberances 44 engage and align with the brazing sheet cut-outs 64.

If the fitting 60 is misaligned, the protuberances 44 should contact the brazing sheet 48 and can prevent the fitting 60 from being positioned on the heat exchanger 4, and which should be recognized during assembly and corrected ensure proper alignment of the fitting 60 on the brazing sheet 48. The shape of the one or more protuberances 44 is not particularly limited and can be varied depending upon design and application requirements. In the second embodiment disclosed herein, the protuberances 44 have a rectangular shape. In addition, although not shown, the protuberances 44 can extend directly from the fitting 60, rather than structural plate 62 of the fitting 60. Such features can help proper alignment and positioning of features in a heat exchanger assembly 2.

In another embodiment (not shown), the protuberances 44 can extend from a surface of the fitting 60, extending towards the structural plate 62 and brazing sheet 48. The structural plate 62 can be provided with one or more structural plate cut-outs and/or one or more structural plate slits to receive the protuberances. In addition, the brazing sheet 48 can be provided with one or more brazing sheet cut-outs and/or one or more brazing sheet slits to receive the protuberances extending from the fitting. When assembling, the protuberances from the fitting would engage the one or more structural plate cut-outs and/or one or more structural plate slits before engaging the one or more brazing sheet cut-outs and/or one or more brazing sheet slits to align and affix the fitting assembly to the heat exchanger 4.

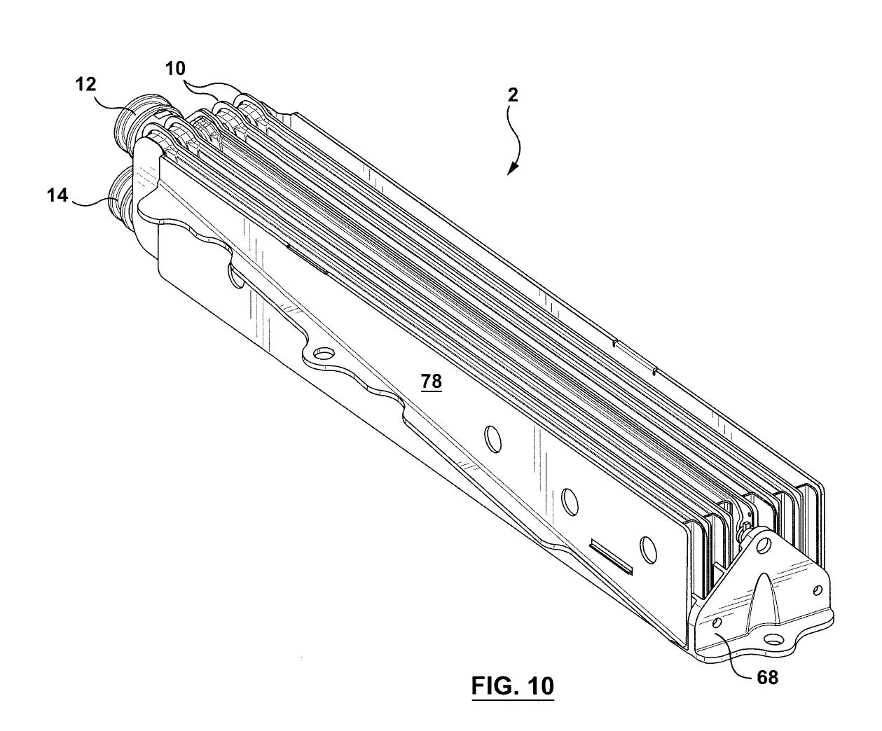

FIGS. 10-12 relate to a third embodiment of a heat exchanger assembly 2 disclosed herein. In particular, the third embodiment of the heat exchanger assembly 2 relates to a charge air cooler (CAC), however, the disclosure of the third embodiment can be applied to other types of heat exchanger assemblies 2 as well, as should be recognized by a person of skill in the art.

The heat exchanger assembly 2 according to the third embodiment has a heat exchanger core 4 formed by a plurality of heat exchanger plates 10. In a typical charge air cooler (CAC), the heat exchanger core 4 contains a plurality of plate pairs that together define a passages for a first fluid and second fluid, and permit heat exchanger between the first and second fluids, as should be known to a person of skill in the art. In addition, the heat exchanger 4 is provided with an inlet 12 and outlet 14 for flow of a first fluid to enter and exit the heat exchanger 4. At an opposing end from the inlet 12 and outlet 14, the heat exchanger 4 can be coupled to a bracket 68 to hold the heat exchanger 4 together. The heat exchanger 4 used in the description should be known to a person of skill in the art and is not particularly limited, and can be varied depending upon design and application requirements.

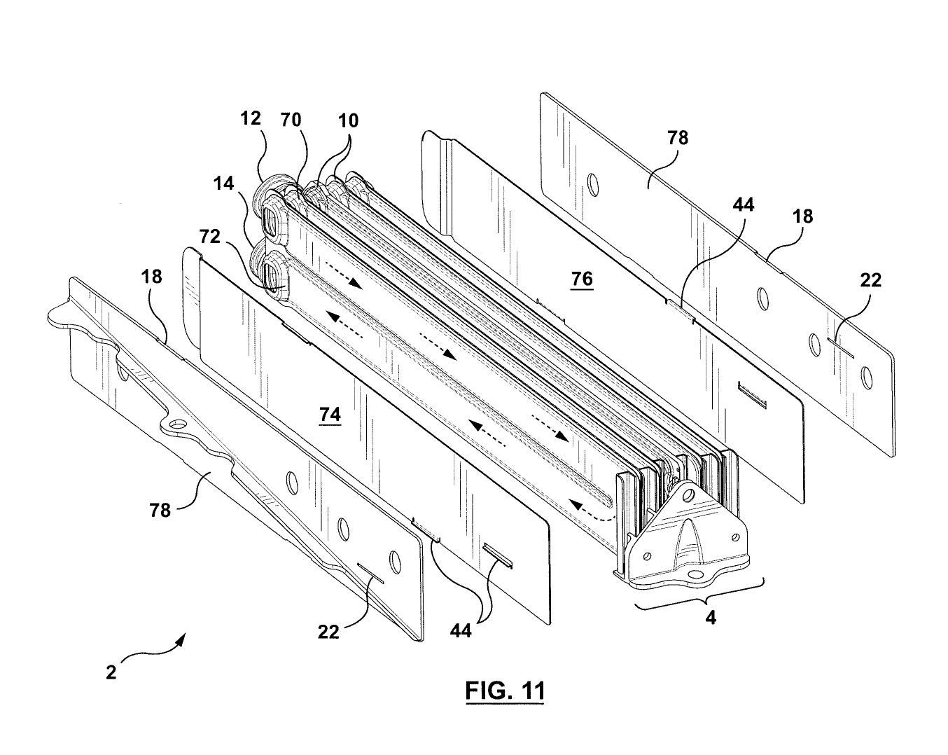

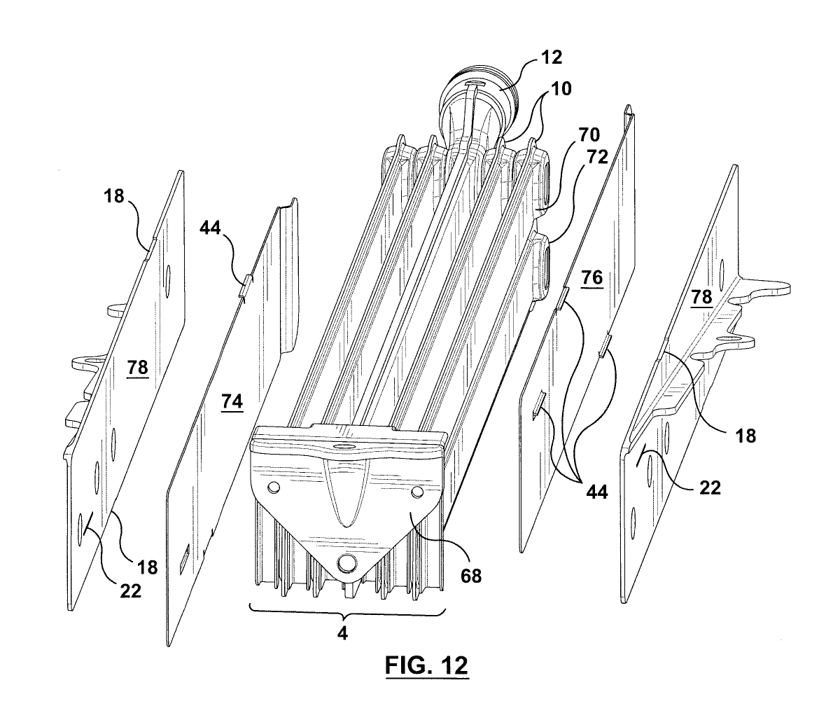

As shown in FIGS. 11 and 12, the plurality of heat exchanger plates 10 together defines a first fluid inlet manifold 70 and a first fluid outlet manifold 72. Fluid entering the inlet 12 travels into the first fluid inlet manifold 70, and then enters a first fluid passage (not shown) to the opposing end (as shown by arrows in FIG. 11) towards the bracket 68, before turning and travelling back towards the end having the inlet 12 and outlet 14. Upon returning, fluid collects in the first fluid outlet manifold 14, before exiting the heat exchanger 4 from the outlet 14.

As shown in FIGS. 11 and 12, the heat exchanger assembly 2 is provided with a top heat exchanger cover plate 74 and a bottom heat exchanger cover plate 76, which are coupled to the heat exchanger 4 on opposing sides. The top heat exchanger cover plate 74 and bottom heat exchanger cover plate 76 are sized to be similar to the size and dimensions of the plurality of heat exchanger plates 10. Once the top and bottom heat exchanger cover plates 74, 76 are positioned on the heat exchanger 4, the edges of the top and bottom heat exchanger cover plates 74, 76 align with edges of the plurality of heat exchanger plates 10, and can be brazed or welded to couple the top and bottom heat exchanger cover plates 74, 76 to the heat exchanger 4, using means that should be known to a person of skill in the art. This can help to ensure to ensure that openings in the heat exchanger plates 10, such as those that help form the first fluid inlet and outlet manifolds 70, 72 is covered by the top and bottom heat exchanger cover plates 74, 76. In addition, coupling the heat exchanger 4 to the top and bottom heat exchanger cover plates 74, 76 can provide structural stability to the heat exchanger 4.

The top and bottom heat exchanger cover plates 74, 76 can be provided with one or more protuberances 44, extending from the top and bottom heat exchanger cover plates 74, 76 and away from the heat exchanger 4. The number, size, shape and position of the protuberances is not particularly limited, and can be varied depending upon design and application requirements. However, the number, size, shape and position of the protuberances 44 should be such that the coupling and proper sealing of the top and bottom heat exchanger cover plates 74, 76 to the heat exchanger 4 is not compromised.

In the embodiment shown in FIGS. 11 and 12, a single protuberance 44 extends from the planar surface of the top and bottom heat exchanger cover plates 74, 76 and a pair of protuberances 44 extend from the edges of the top and bottom heat exchanger cover plates 74, 76. However, as should be recognized by a person of skill in the art, the number of protuberances from the planar surface or edges is exemplary only, and can be one or more, depending upon design and application requirements.

In one embodiment, the protuberance 44 extending from the planar surface can be formed by creating a cut in the planar surface and bending the planar surface to form the protuberance 44. While, for example and without limitation, the protuberances 44 extending from edges can be formed in the manufacture of the top and bottom heat exchanger cover plates 74, 76, by having a lip, which can be bent to form the protuberance 44.

Once the top and bottom heat exchanger cover plates 74, 76 are coupled to the heat exchanger 4, the heat exchanger assembly 2 can be coupled to a frame or other supporting structure 78. In the embodiment shown in FIGS. 10-12, the frame or supporting structure 78 has a slit 22 and cut-outs 18 to receive the protuberances 44 from the top and bottom heat exchanger cover plates 74, 76 to ensure proper alignment and positioning of the heat exchanger 4 with the frame or supporting structure 78. The protuberance 44 from the planar surface of the top and bottom heat exchanger cover plates 74, 76 can be inserted into the slit 22 formed in the frame 78 to engage the frame, while the protuberances 44 extending from the edges of the top and bottom heat exchanger cover plates 74, 76 are received in the cut-outs formed in the edges of the frame or supporting structure 78 to clip the heat exchanger assembly 4 to the frame or supporting structure 78. Once in place, the heat exchanger assembly 4 can be welded or brazed, or coupled to the frame 78 using means that should be known to a person of skill in the art.

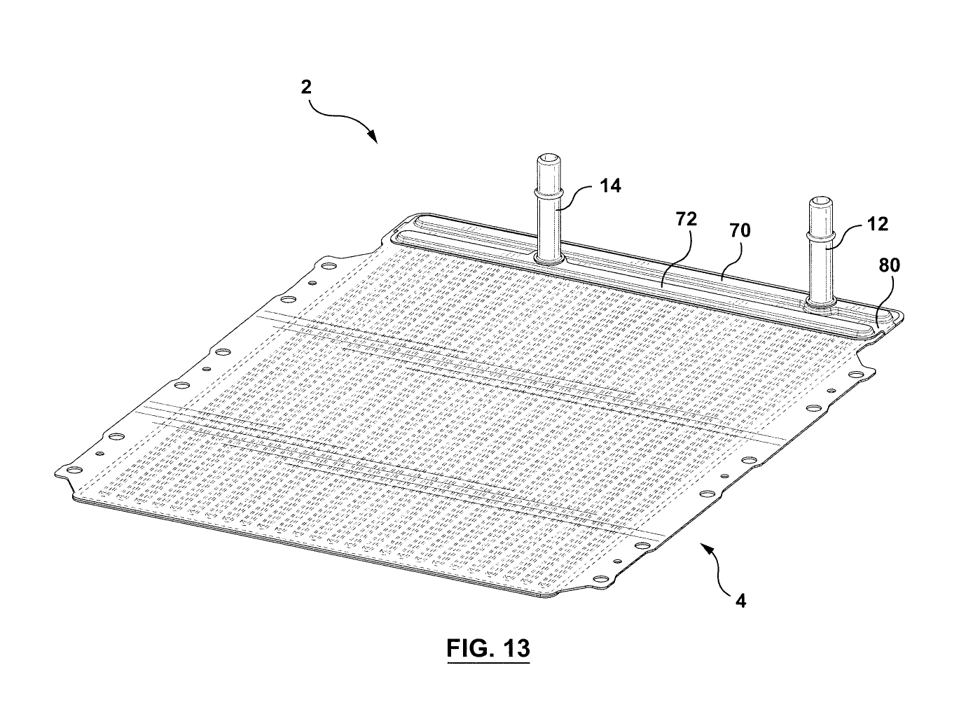

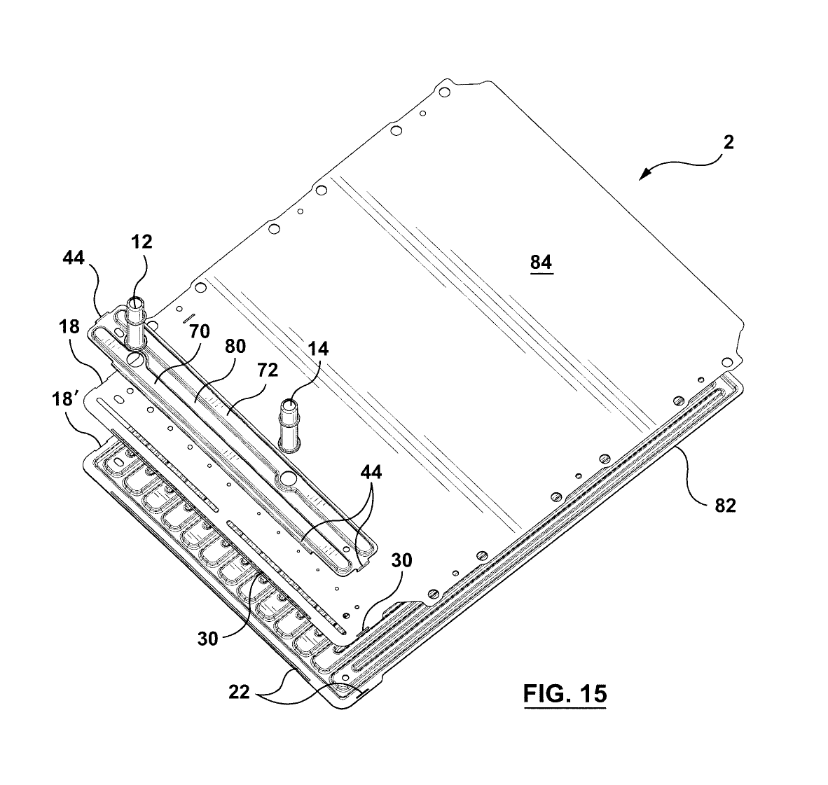

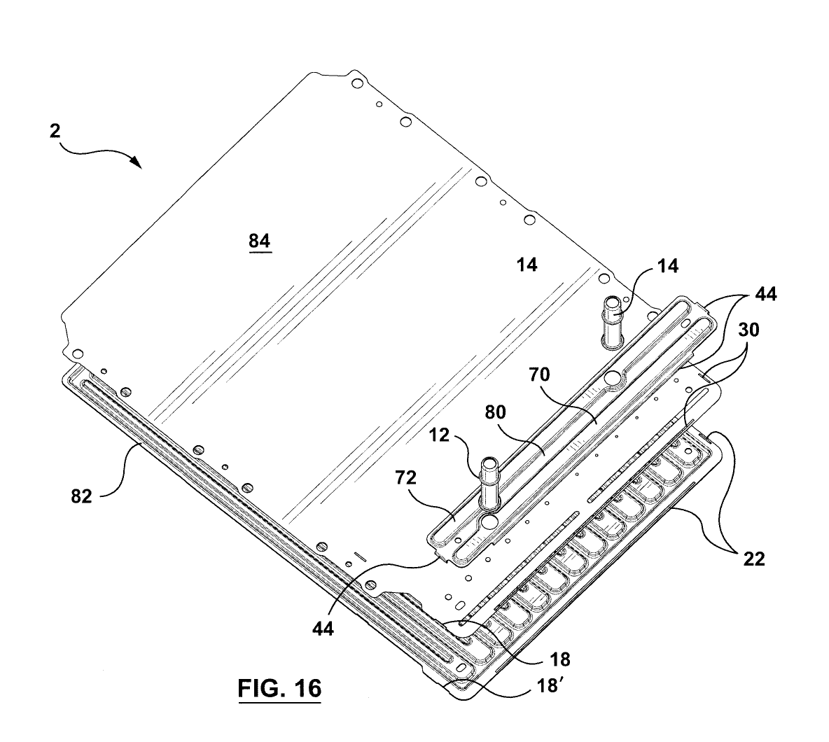

FIGS. 13-16 relate to a fourth embodiment of a heat exchanger assembly 2 disclosed herein. The fourth embodiment of the heat exchanger assembly 2 relates to a battery cell cooler type heat exchanger assembly 2, however, as should be recognized by a person of skill in the art, the teachings of the battery cell cooler and the features disclosed herein for locating and affixing the different parts of the battery cell cooler type heat exchanger assembly 2 can be used with other types of heat exchanger assemblies.

FIG. 13 shows a perspective view of a heat exchanger assembly 2, where the heat exchanger 4 is formed by a plate pair, with one of the plates (first plate 82) of the plate pair having undulations to define a flow path for flow of a heat exchange fluid. The second plate 84 of the plate pair can be a flat plate and provides a surface for placing a battery cell, and from where heat exchange can take place between the battery cell and the fluid flowing between the plate pair of the heat exchanger 4. The heat exchanger assembly 2 is also provided with a manifold plate 80 having a first fluid inlet manifold 70 and a first fluid outlet manifold 72. The first fluid inlet manifold 70 has an aperture which is in fluid communication with an inlet 12. Similarly, the first fluid outlet manifold 72 has an aperture which is in fluid communication with an outlet 14. Hence, fluid entering the inlet 12 can pass into the first fluid inlet manifold 70 before flowing in the passage between the plate pairs 82, 84 of the heat exchanger 4. The fluid then flows from the passage of the heat exchanger 4 to the first fluid outlet manifold 72 before exiting through the outlet 14. It should be noted that battery cell cooler type heat exchanger assemblies are known by a person of skill in the art should.

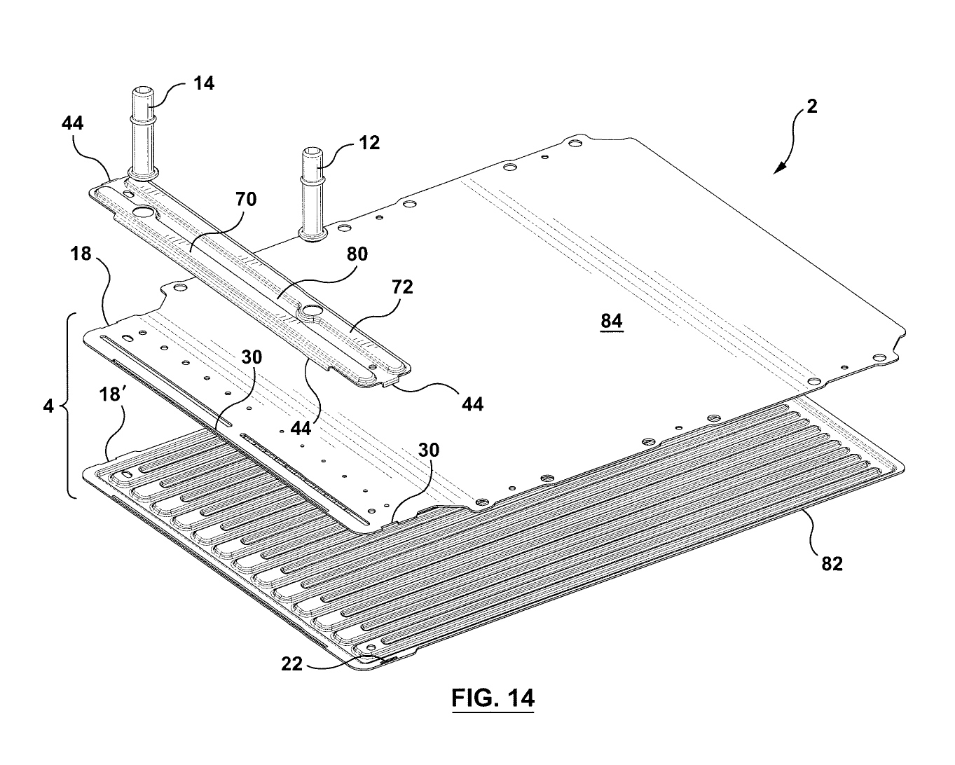

To ensure proper alignment and positioning of the different components of the heat exchanger assembly 2, the manifold plate 80 can be provided with one or more protuberances 44. In the embodiment shown in FIGS. 14-16, the manifold plate 80 is provided with three protuberances 44 positioned proximate to the peripheral edge of the first and second plates 82, 84. However, as should be recognized by a person of skill in the art, the number and position of protuberances can be varied depending upon design and application requirements. Further, the protuberances 44 extend from the manifold plate 80 towards the first and second plates 82, 84, when the manifold plate 80 is brought close to the first and second plates 82, 84 for assembly.

To form the heat exchanger assembly 2, the second plate 84 of the heat exchanger 4 is provided with one or more slots 30 and one or more cut-outs 18 to receive the protuberances 44 on the manifold plate 80. The number of slots 30 and cut-outs 18 correspond to the number of protuberances 44. In addition, the slots 30 and cut-outs 18 are positioned on the second plate 84 such that when the manifold plate 80 is properly positioned on the second plate 84, the protuberances 44 can engage and be received within the slots 30 and cut-outs 18.

In the embodiment shown in FIGS. 14-16, the second plate 84 has two slots 30 positioned near the peripheral edges of the second plate 84. Although, the slots 30 are formed near peripheral edges of the second plate 84 that are perpendicular to each other, as should be recognized by a person of skill in the art, the slots 30 can be formed near opposing edges of the second plate 84. Further, in the embodiment shown in FIGS. 14-16, a cut-out 18 is formed at one of the edges of the second plate 84. Although a single cut-out 18 has been shown, as should be recognized by a person of skill in the art, the second plate 84 can be provided with multiple cut-outs 18 shaped and positioned to receive and engage with the protrusions 44 of the manifold plate 80.

The first plate 82 of the heat exchanger 4 is provided with corresponding slits 22 and cut-outs 18′ (also noted as ‘first plate cut-outs’). The number of slits 22 and first-plate cut-outs 18′ correspond to the number of protuberances 44 in the manifold plate 80. In addition, the slits 22 and first plate cut-outs 18′ are positioned on the first plate 82 such that when the manifold plate 80 is properly positioned on the second plate 84, the protuberances 44 pass through the slots 30 and slits 22 in the second plate 84 and first plate 82, respectively, while engaging and clipping with the cut-outs 18, 18′ in the second and first plate 84, 82 to ensure proper positioning and assembly of the heat exchanger assembly 2.

The features disclosed herein can help to ensure proper positioning and alignment of the different components of the heat exchanger assembly 2, other than the heat exchanger 4 (formed by the plurality of heat exchanger plates 10). Once properly aligned and positioned, the different components of the heat exchanger assemblies 2 can brazed or welded to affix the components in place and ensure that the components are properly positioned.

Certain adaptations and modifications of the described embodiments can be made. Therefore, the above discussed embodiments are considered to be illustrative and not restrictive.

### PARTS LIST

| No. | Description |
|---|---|
| 2 | Heat exchanger (HX) assembly |
| 4 | Heat exchanger |
| 6 | Base plate (BP) |
| 8 | Valve integration unit |
| 10 | Heat exchanger plates |
| 12 | Heat exchanger inlet |
| 14 | Heat exchanger outlet |
| 16 | Cover plate |
| 18 | Cut-out in cover plate |
| 20 | pair of opening in BP |
| 22 | Slit |
| 24 | Brazing sheet |
| 26 | 1^{st} aperture |
| 28 | 2^{nd} aperture |
| 30 | Slot |
| 32 | Valve housing |
| 34 | 1^{st} end of valve housing |
| 36 | 2^{nd} end of valve housing |
| 38 | Channel |
| 40 | Orifice at 1^{st} end of valve |
| | housing |
| 42 | Valve assembly |
| 44 | Protuberance |
| 46 | Opening on top plate of HX |
| 48 | brazing sheet of 86 |
| 50 | Bottom plate of heat |
| | exchanger |
| 52 | 1^{st} end of brazing sheet |
| 54 | 2^{nd} end of brazing sheet |
| 56 | First side of channel |
| 58 | Second side of channel |
| 60 | Fitting |
| 62 | Structural plate |
| 64 | Cut-out in brazing sheet |
| 66 | Contact surface |
| 68 | Bracket |
| 70 | First fluid inlet manifold |
| 72 | Second fluid inlet manifold |
| 74 | top heat exchanger cover plate |
| 76 | Bottom HX cover plate |
| 78 | Frame |
| 80 | Manifold plate |
| 82 | First plate |
| 84 | Second plate |
| 86 | Fitting assembly |

1-20. (canceled)

21. A heat exchanger assembly, comprising:
a heat exchanger having at least a plate pair, the plate pair defining a fluid passage for flow of fluid for heat exchange, and optionally coupled a base plate of the heat exchanger assembly; and
a component coupled to the heat exchanger or the base plate of the heat exchanger assembly, where the base plate is coupled to a bottom plate of the heat exchanger; the component having a plurality of parts, where one part of the plurality of parts has one or more protuberances, the one or more protuberances engaging a slit or cut-out for coupling the component.

22. The heat exchanger assembly according to claim 21, wherein the heat exchanger is formed by a plurality of plates, the plurality of plates together defining fluid passages for a first fluid and a second fluid for heat exchange between the first fluid and the second fluid; the plurality of heat exchanger plates having the bottom plate coupled to the base plate of the heat exchanger assembly; and
an inlet and an outlet coupled to the heat exchanger, the inlet and the outlet in fluid communication with the fluid passage for the first fluid to permit the first fluid to enter and exit from the heat exchanger.

23. The heat exchanger assembly according to claim 22, wherein the component is a valve integration unit coupled to the base plate; the valve integration unit having a brazing sheet sandwiched between the base plate and a valve housing;
the valve housing having one or more protuberances extending from a first side of the valve housing;
the brazing sheet having one or more slots for receiving the one or more protuberances extending from the first side of the valve housing; and
the base plate having one or more slits for receiving the one or more protuberances extending from the first side of the valve housing, and wherein the protuberances extending from the first of the valve housing, the one or more slots on the brazing sheet and the one or more slits on the base plate being aligned to permit affixing of the brazing sheet between the valve housing and the base plate.

24. The heat exchanger assembly according to claim 23, wherein the valve integration unit has a cover plate, the cover plate having one or more cut-outs; and
the valve housing having one or more protuberances extending from a second side of the valve housing, the second side of the valve housing being opposed to the first of the valve housing, and the one or more protuberances from the second side of the valve housing aligning with and engaging the one or more cut-outs in the cover plate.

25. The heat exchanger assembly according to claim 24, wherein the brazing sheet has a first aperture and a second aperture at opposed ends of the brazing sheet; the first aperture fluidly aligned with one of a pair of openings in the base plate, the second aperture fluidly aligned with the other of the pair of openings in the base plate; and
the valve housing having a first end, a second end, a channel extending from the first end to the second end and an orifice at the first end of the valve housing; the first end of the valve housing adapted for receiving a valve assembly, and the orifice permitting fluid flow to the channel or the first aperture in the brazing sheet.

26. The heat exchanger assembly according to claim 25, wherein the one or more protuberances extending from the first side and the second side of the valve housing are positioned between the first end and the second end of the valve housing.

27. The heat exchanger assembly according to claim 21, wherein the heat exchanger is formed by a plurality of plates, the plurality of plates together defining fluid passages for a first fluid and a second fluid for heat exchange between the first fluid and the second fluid; the plurality of heat exchanger plates having the bottom plate coupled to the base plate of the heat exchanger assembly; and
the component is an inlet fitting assembly, the inlet fitting assembly having a structural plate positioned between a brazing sheet and an inlet fitting;
the brazing sheet having an aperture in fluid communication with the fluid passage for the first fluid defined by the plurality of plates, and the brazing sheet coupled to a top plate of the plurality of plates of the heat exchanger;
the structural plate having an opening aligned and in fluid communication with both the aperture in the brazing sheet and an inlet in the inlet fitting permitting fluid to flow from the inlet to the fluid passage for the first fluid.

28. The heat exchanger assembly according to claim 27, wherein the structural plate has one or more protuberances extending from a contact surface of the structural plate and extending towards the brazing sheet; and
the brazing sheet having a one or more cut-outs for receiving and affixing the contact surface to the brazing sheet.

29. The heat exchanger assembly according to claim 28, wherein the one or more cut-outs in the brazing sheet are formed from an edge of the brazing sheet defining the aperture.

30. The heat exchanger assembly according to claim 29, wherein the structural plate has at least two or more protuberances extending from the contact surface of the structural plate and extending towards the brazing sheet; and
the brazing sheet has one or more slits for receiving the second or more protuberances extending from the contact surface of the structural plate.

31. The heat exchanger assembly according to claim 27, wherein the fitting has one or more protuberances extending from a surface of the fitting and extending towards the brazing sheet;
the structural plate has one or more structural plate slits or one or more structural plate cut-outs for receiving the protuberances extending from the surface of the fitting; and
the brazing sheet has one or more brazing sheet slits or one or more brazing sheet cut-outs for receiving the protuberances extending from the surface of the fitting.

32. The heat exchanger assembly according to claim 31, wherein the one or more cut-outs in the brazing sheet are formed from an edge of the brazing sheet defining the aperture.

33. The heat exchanger assembly according to claim 21, wherein the heat exchanger is formed by a plurality of plates, the plurality of plates together defining fluid passages for a first fluid and a second fluid for heat exchange between the first fluid and the second fluid; and
the heat exchanger assembly having:
a top heat exchanger cover plate coupled to an end heat exchanger plate, the top heat exchanger cover plate having one or more protuberances extending from the top heat exchanger cover plate, the one or more protuberances extending away from the plurality of plates of the heat exchanger; and
a frame having one or more slits and/or one or more cut-outs for receiving the one or more protuberances.

34. The heat exchanger assembly according to claim 33, wherein the one or cut-outs are formed at an edge of the frame.

35. The heat exchanger assembly according to claim 34, further comprising:
a bottom heat exchanger cover plate coupled to a second end heat exchanger plate, the bottom heat exchanger cover plate having one or more protuberances extending from the bottom heat exchanger cover plate, the one or more protuberances extending away from the plurality of plates of the heat exchanger; and
a second frame having one or more second frame slits and/or one or more second frame cut-outs for receiving the one or more protuberances extending from the bottom heat exchanger cover plate.

36. The heat exchanger assembly according to claim 35, wherein the one or second frame cut-outs are formed at an edge of the second frame.

37. The heat exchanger assembly according to claim 21, wherein the plate pair of the heat exchanger has a first plate and a second plate, and the heat exchanger assembly further comprises a fluid manifold assembly, the fluid manifold assembly having:
a manifold plate coupled to the second plate of the heat exchanger, the manifold plate having one or more protuberances extending from the manifold plate to the second plate of the heat exchanger, and
the second plate having one or more slits and/or one or more cut-outs for receiving the one or more protuberances extending from the manifold plate.

38. The heat exchanger assembly according to claim 37, wherein the manifold plate has a first fluid inlet manifold and a first fluid outlet manifold, the first fluid inlet manifold and first fluid outlet manifold in fluid communication with a fluid passage defined by the first plate and the second plate of the heat exchanger.

39. The heat exchanger assembly according to claim 38, wherein the manifold plate further contains an inlet and an outlet, the inlet being in fluid communication with the first fluid inlet manifold and the outlet being in fluid communication with the first fluid outlet manifold.

40. A method for forming a heat exchanger assembly, comprising:
coupling a first plate and a second plate to form at least a plate pair of the heat exchanger, the plate pair defining a fluid passage for flow of fluid for heat exchange, the heat exchanger optionally having a base plate; and
coupling a component to the heat exchanger or the base plate of the heat exchanger assembly, where the base plate is coupled to a bottom plate of the heat exchanger; the component having a plurality of parts, where one part of the plurality of parts has one or more protuberances, the one or more protuberances engaging a slit or cut-out for coupling the component.
